(19) United States
(12) Patent Application Publication
(10) Pub. No.: US 2012/0151884 A1
(43) Pub. Date: Jun. 21, 2012

(54) Visual Aid

(76) Inventor: Marie Josephine Unsworth, Hampshire (GB)

(21) Appl. No.: 13/319,088

(22) PCT Filed: May 6, 2010
(86) PCT No.: PCT/GB10/00905

§ 371 Date: Nov. 6, 2011

(30) Foreign Application Priority Data
May 6, 2009 (GB) 0907777.7
Oct. 8, 2009 (GB) 0917644.7

(51) Int. Cl. B68B 1/10; A01K 15/00

(52) U.S. Cl. 54/10; 119/836

(57) ABSTRACT

The invention relates to a visual aid (50), and more particularly, but not exclusively the invention relates to a visual aid for horses. The visual aid comprises first and second lateral portions (50a, 50b) that are adapted to be worn by a horse. In use the first portion (50a) is located on a lateral side of the head of the horse in front of the left eye of the horse; and the second portion (50b) is located on a lateral side of the head of the horse in front of the right eye of the horse. The result is that the eyes of the horse are drawn towards a distant fixation point of focus, between a virtual frame defined by the lateral portions, and so avoiding the problem of the horse having to lower its head, in order to see and thereby reducing muscle strain on the horse's eyes and neck.

### FIELD OF THE INVENTION

The invention relates to a visual aid, and more particularly, but not exclusively the invention relates to a visual aid for animals, such as horses, and is hereinafter referred to as an equine visual aid.

1. Background

The eyes of a horse are positioned on each side of the animal's head, allowing it to use monocular vision and giving an expansive field of view, which has evolved from its ability to see threats and predators in its natural habitat. This ability to use peripheral vision, with each eye also being able to look in different directions, provides the horse with the ability of achieving a maximum viewing area.

Depending upon the position of an object the horse may also turn its head. For example a horse may do this, or even turn its whole body, to view a strange stimulus, whether that is in the outdoor setting (eg in a field or paddock) or in a domestic environment (eg in a yard or, within the confines of a stable).

However, when the horse wishes to see an object at close range, it tends to utilise binocular vision, where both eyes are receiving light rays from the object and will also lift or lower its head in order to focus an image of the object on its retina, at the back of its eye. Binocular vision happens when images received from each eye overlap and this creates a narrow field of view in front of the horse, which enables stereoscopic vision. It is the stereoscopic vision that provides the horse with the ability to judge and perceive depth of field and interpret a three dimensional perspective.

2. Prior Art

In order to help horses concentrate, for example when racing, visual aids, such as sheepskin nosebands have been used. However, these suffer from a number of drawbacks; in particular the horse has tended to hold its head at an unnecessarily steep angle of tilt in order that it can view above the noseband. Other aids, such as blinkers or visors, are positioned to block rear peripheral vision and can cause a horse to move its head from left to right in an attempt to try and see a wider field of view.

One example of a device that is a blinker or blind for horses is described in US Patent U.S. Pat. No. 468,238 (Cather). The device is intended to prevent animals, in particular horses and cows, from jumping. It performs this function by effectively concealing the front field of view. The device is therefore adapted to prevent the animal wearing to from seeing directly ahead, but at the same time enable the animal to see whilst grazing.

Another example of a head protector for horses is described in U.S. Pat. No. 342,186 (Corley). The head protector includes a blinker attached to the bridle. The blinker completely obscures the lateral fields of view of each eye of the horse.

The aforementioned blinkers are intended to guard against the effect that can occur when a horse is ridden in a public area and jumps or shies away from an unknown object, for example when a sudden image is received in its field of peripheral vision. In such situations the horse may pose risks to bystanders or for users of private or public transport, for example if on a highway. This may also be potentially dangerous for the individual rider and for the safety of the horse by avoiding injury.

Nosebands, for example sheepskin nosebands, serve mainly to encourage the horse to hold its head in a more downward inclined angle. This was done in order to control a horse which has a tendency to lift its head or shake it unnaturally. This is likely to be physically uncomfortable for the horse as well as potentially causing eye strain, as extra-ocular muscles are being forced to compensate for the lowering of the head, whilst the horse still wants to see ahead of itself, or is being ridden in a forward direction by its rider.

The result has often been an unnecessary lowering of the nose, so as to make the eyes look upwards, in a superior aspect in the vertical meridian. In humans the same cause has resulted in considerable discomfort, causing fatigue as well as visual disturbance, as the muscles controlling movement in the vertical meridian are designed to move in a more restricted manner than those in the horizontal meridian. Therefore it has not been normal to sustain fixation in this unnatural orientation in the vertical position, for any extended period of time, without placing additional stress on the ocular system.

It is likely that this same physical discomfort is also experienced by a horse when it is forced into this unnatural head position. This type of appliance causes a barrier, or restricted field of view, in the frontal visual field, when stereoscopic vision is required, which is particularly important when running at speed or when jumping an obstacle such as a hurdle, gate or fence.

A further example of an appliance used by a horse is described in French Patent Application FR-A1-2 713 217 (Fattaccini). The device is used as an eye protector or eye shield.

A further example of a so-called bridle-blind is described in US Patent U.S. Pat. No. 85,406 (Simis) which described and claims a rein with bifurcating parts for the purpose of pressing against blinds or blinkers, so that blinkers may be pulled over a horse's eyes by a rider.

The aforementioned devices have performed their intended function. However, in recent years there have been advances in the understanding of human vision and the principles of visual fatigue are long noted in human ocular anatomy. There is now a greater understanding of the effect that stresses and strains have upon extra ocular muscles. The inventor has applied this knowledge to understanding how animals eyes, more particularly equine eyes, interpret visual signals In applying the principles employed in human vision, especially the importance of understanding movement of human eyes in the optometric field of sport vision and how enabling binocular vision enhances human athletic performance, it is reasonable to infer that an animal, such as a horse, benefits from an improved visual aid.

The present invention arose in order to overcome various shortcoming associated with the aforementioned devices and seeks to provide an improved visual aid that will enhance the ability of an animal to focus visually and so improve its performance.

### SUMMARY OF THE INVENTION

According to a first aspect there is provided a visual aid comprising: first and second lateral portions that are adapted to be worn by an animal so that, in use, the first lateral portion is located on a lateral side of the head of the animal in line of the frontal visual axis of the left eye of the animal and between the nostril; and the second lateral portion is located on a lateral side of the head of the animal in line of the frontal visual axis of the right eye of the animal and between the nostril.

The invention is particularly well suited for use by horses and affects the ocular muscle system rather than operating as an eye protector or eye shield. Enhanced performance, both visually and increased athletic prowess, whether that is in accurate jumping, manoeuvring, or running at greater speed with a more confident forward momentum, has been observed in horses wearing the visual aid.

Preferably the lateral portions of the visual aid are attachable to (and detachable from) a bridle, usually at the junction of the noseband and the cheek pieces Where a noseband is not utilised, lateral portions may also be attached directly to the horse's face with adhesive or adhesive tape or a connective strap.

The visual aid is ideally adapted to be displaceable along an axis of the bridle so as to be adjustable towards and away form the horse's eyes.

It is appreciated therefore that use of the visual aid creates an area in front of the horse's eyes, which encourages the horse to look “through” two post-like forms and focus beyond the visual aid. The visual aid therefore defines an area in the visual field of view of the horse, which effectively acts as a “funnel” for the horse to look through. The invention is therefore different from the aforementioned blinkers and eye shields and, rather than provide a distraction to the horse, which was the case previously with sheepskin nosebands, it provides a virtual frame into which the horse's focus is drawn naturally with minimum visual stress. This is because, unlike a solid band positioned across the nose that poses an obstruction and creates a continuous ocular distraction, the visual aid defines two independent, relatively narrow, first and second lateral portions that define left and right edges of a frame through which the horse can see a complete field of view.

In use the lateral regions of the field of view change as the horse gallops ‘into’ the space defined between the two lateral portions. This has been found to be more effective for the horse and less strenuous on its neck and eye muscles because rather than the horse having to force its head into an unnatural angle in order to see a full field of view (so as to be able to see over a noseband) it is able to hold its head higher in a more natural posture and so avoid detracting from its natural posture and gait.

Optionally the visual aid is produced in the form of a buffer or roll made of sheepskin or some other material and defines a simple, low profile contoured shape across the muzzle of the horse, presenting finger-like projections at the right and left side of the horse's head. By hugging the horse's facial features a shadow or shadow area is formed in the frontal sphere of vision of each eye of the animal by the lateral projections. This causes the horse naturally to move its eyes towards a more central space, defined by the edges of a frame between the first and second lateral portions of the visual aid. It is apparent that this is the optimum area for visual interpretation and is achieved effectively by creating a simple fixation point, for close or distant objects, the near and far focussing being achieved by the combination of movement of the eyeball and muscles within the eye. By way of analogy a human sprinter is often taught to visualise an end point in a race beyond the finish line, thereby improving visual focus and concentration when such a forward fixation point has been identified and established.

The visual aid is typically formed from a single piece or two or more interconnected piece(s) of natural or simulated sheepskin, or another material, which has been cut or formed into either a generally square or rectangular shape. The height, thickness and breadth of the visual aid may be varied according to the facial measurements of the animal.

If wool or a fibrous material is employed, ideally the length of the fibres or wool is varied between 1-4 cm depending upon the visual requirement of the horse or according to the task that is being undertaking. Such fibrous materials may be supplied in a ‘longer than needed’ form and cut to size in situ or prior to use.

The length and overall size of the visual aid is advantageously determined by the measurement equal to the distance from one side of the bony bridge of the horse's face, generally near to the bit position on the bridle to the top of the horse's nostril. This length is dimensioned so that in use it meets a virtual line defined by intersection of two planes defined as passing through the centre of each eye of the horse. When the horse is looking forwards these planes include a line between the outer canthus of each eye orbit to the horse and respective nostrils so defining a vertical line of intersection directly in front of the horse as it looks forwards. The line of intersection of the two planes is referred to as the frontal visual axis. It is important that the length of the lateral portions of the visual aid, hereinafter also referred to as a buffer, are such as not to intrude into the visual field of view when maximum convergence is achieved.

In an alternative embodiment the visual aid may have a flatter aspect ratio or it may be cylindrical (sausage) shaped or tubular in design.

The visual aid is preferably attachable to an existing bridle by hook-and-eye such as Velcro (Registered Trade Mark) fastening means or by means such as hook and loop tape or by slits cut within the rear backing that are for example adapted to wrap around a bridle. These fastening means, tapes or backing allow for a noseband, which is sometimes part of the bridle, to slide easily through openings formed on a support (strap) for the visual aid. This ensures that lateral portions remain attached to the correct region of the bridle, thereby ensuring the important vertical positioning of the visual aid. This is also desirable as it ensures that the lateral portions do not slide up or down the horse's bridge and so alter its field of view in normal usage. In some horses, there may be a need to raise the buffer so that the top of each buffer sits more prominently on one or both sides of the horse's bridge.

If the lateral portions are in tubular form, the sheepskin has a residual height and so presents an even image of itself in the horse's field of view, regardless of whether the visual aid moves or twists in wear. This can be achieved using either natural or synthetic materials and is not restricted by the material used.

Maintenance of the vertical positioning is important for the visual aid to work effectively. Physical contours of the visual aid may differ according to the type of material used and also according to the visual task. As horses have restricted colour vision, certain colours and dyes for the fabric materials, may be added to emphasise edges of the lateral portions from the horses viewpoint. A darker colour may produce a more obvious edge to the visual aid and so encourage the horse's eyes to fixate, and therefore converge more easily or readily. Colours or regions of different colour or shade or pattern may be used individually or in combination on any single buffer unit.

It is apparent that the visual aid has many advantages over existing sheepskin nosebands and other commercial items that are currently used with the claim of helping the horse to focus or concentrate and it is understood that the visual aid allows for natural, unobstructed rear and forward vision.

Preferred embodiments of the invention are now described, with reference to the Figures, in which:

### BRIEF DESCRIPTION OF THE FIGURES

FIG. 1a is an above plan view of a horse and shows the area of monocular field of view as perceived by the horse's left eye;

FIG. 1b is an above plan view of a horse and shows the area of monocular field of view as perceived by the horse's right eye;

FIG. 1c is an above plan view of a horse and shows the area of binocular field of view, in front of the horse, and as perceived by both the horse's eyes;

FIG. 2 is a front view of a horse showing fields of view;

FIG. 3 is a front view and shows maximum extension (rotation) of the right and left eyes and how this creates monocular overlap and a binocular viewing region;

FIG. 4a is a front view of an embodiment of a visual aid positioned on the bridge of the horse;

FIG. 4b is a front view of an embodiment of a visual aid positioned higher up on the bridge of the horse than the view in FIG. 4a;

FIG. 5 shows diagrammatically fixation points in a binocular visual field exerting unequal convergence;

FIG. 6 depicts a fixation point in a binocular visual field exerting equal convergence;

FIG. 7 is a frontal view of a horse, showing a head-on view of the flattened lateral portion of the visual aid, maintaining the binocular region;

FIG. 8 is a side view of a horse's head and shows an example of a flattened lateral portion of the visual aid in FIG. 7 and position of alternative vertical locations;

FIG. 9 is a frontal view of a horse, showing location of the visual aid and shows monocular and binocular fields of view and the location and angle of orientation of the visual fields of reference;

FIGS. 10a to 10c show various views of embodiments of a flattened visual aid, with a slit cut;

FIGS. 11a to 11d show plan views of alternate embodiments of the visual aid, with lateral portions interconnected by a strip or flattened region;

FIG. 11e is an elevation view of an embodiment of the visual aid, with several finger-like lateral projections;

FIG. 12 is an alternate embodiment of the visual aid shown in FIG. 11, in which the several finger-like lateral projections are angled with respect to an underlying suede or skin of the sheepskin;

FIG. 13a illustrates how the several finger like lateral projections, of the embodiment in FIG. 11e open apart when the visual aid is being worn by the horse;

FIG. 13b illustrates how the finger like lateral projections, of the embodiment in FIG. 12 open apart when the visual aid is being worn by the horse;

FIG. 14 is a view of the horse from the front wearing the visual aid shown in FIG. 11;

FIG. 15a is an overall diagrammatic view of an alternative embodiment of a visual aid comprising tubular formation incorporating a roll of material or fabric with overlapping edges to form a tubular structure

FIG. 15b is an overall diagrammatic view of an another embodiment of a visual aid, in which different shapes have been cut, examples of which are shown for illustrative purposes;

FIGS. 16a and 16b are plan and side elevation views of another embodiment and show a portion of sheepskin with extended connections; and

FIGS. 17a and 17b show alternate positions of the buffer as placed on differing styles of existing nosebands.

### DETAILED DESCRIPTION OF PREFERRED EMBODIMENTS OF THE INVENTION

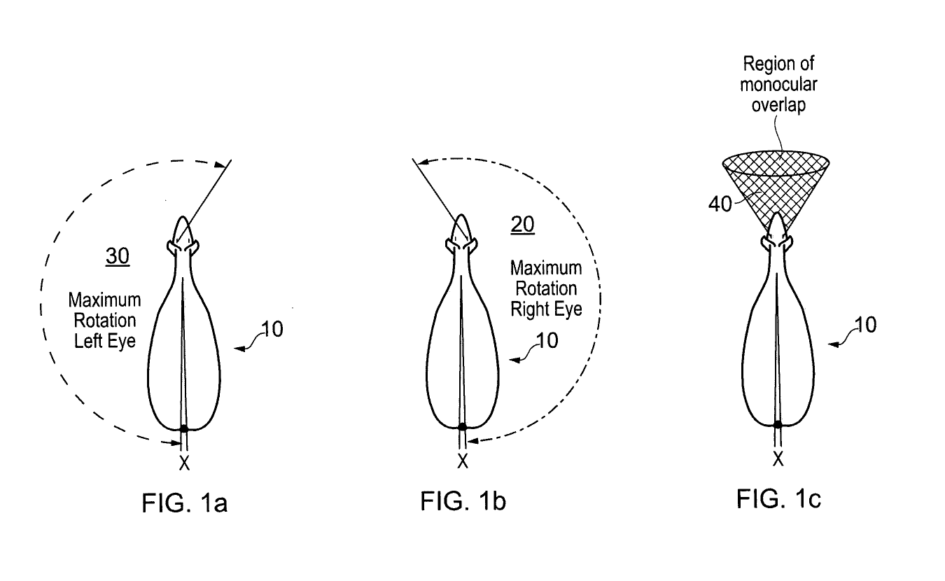

Reference is made initially to FIGS. 1 to 4 so as to provide a visual frame of reference so as to assist in the understanding of the invention.

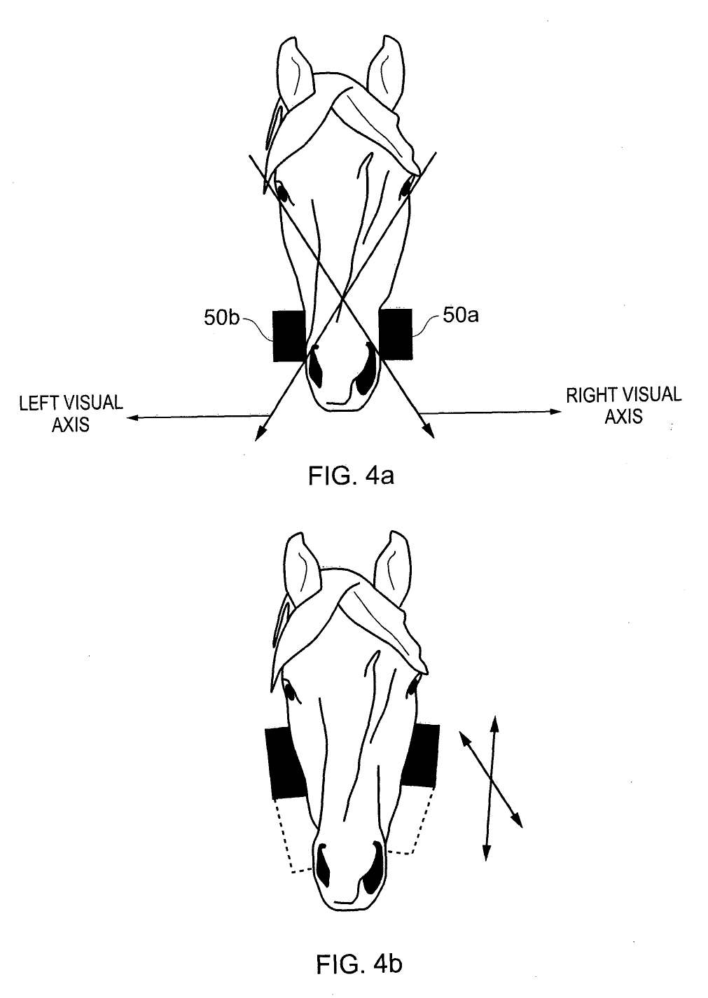

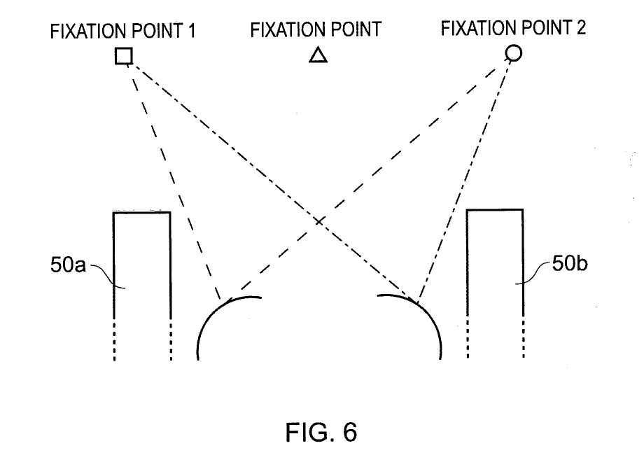

Referring to FIG. 1 there is shown a horse 10 from above, depicting right monocular field 20 and left monocular field 30 and an area of binocular field of view 40 as perceived from the horse's perspective. A blind spot is depicted as ‘X’ at the rear of the horse. As the horse 10 uses the visual aid 50 according to the invention, as shown in FIG. 4a and described below, it learns to look through the gap or a virtual frame, defined between left 50a and right 50b vertical buffers. The visual aid may be used singly or in pairs, (as shown) on either side of the horse's bridle or halter, to realise a visual fixation point and improve optical performance by focussing through the frame to optimum fixation points as shown in FIG. 6. In this manner, the visual aid (described below) trains the animal to understand where the best vision is achieved and therefore engenders a proprio-receptive response to the wearing of the visual aid.

Horses benefit from the use of correct binocular vision, which is explained with reference to FIGS. 1 to 3 inclusive. The safety of both the horse and its rider is paramount, especially when the horse is being ridden by a novice equestrian. A horse that wears the visual aid 50, even if being led by its owner, or is in a non-competitive or non-working environment, is able to gauge objects ahead of itself as well as gauging distances and types of surfaces upon which it walks.

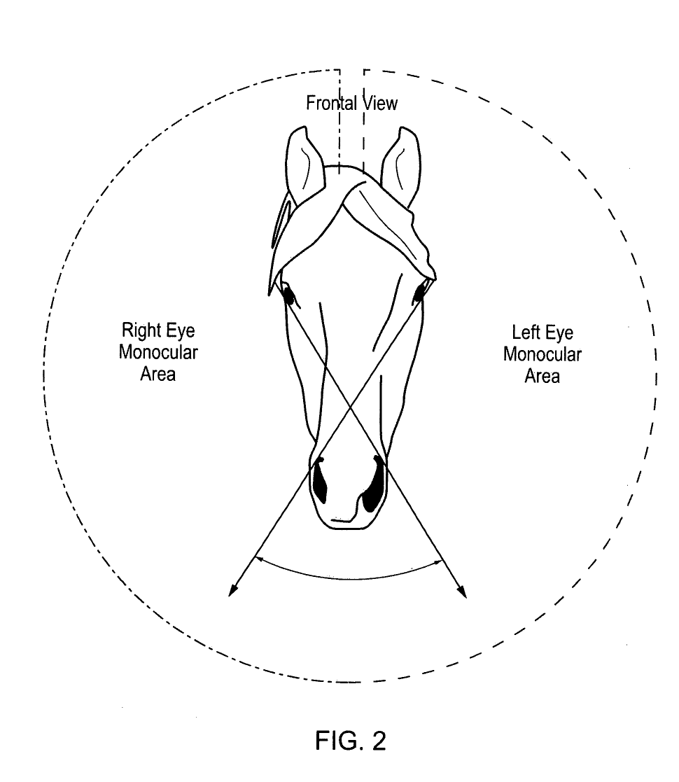

By focusing upon a visual field, defined between the vertically positioned left and right lateral portions or buffers 50a and 50b, effectively in front of the animal, the horse is less distracted by movement in its peripheral viewing area. This is illustrated in FIG. 2 which shows diagrammatically a front view of a horse showing its fields of view. By encouraging forward optimum vision whilst not blinkering lateral fields of view, as performed by other devices, the horse is less distracted and so there are fewer risks of accidents occurring.

As a result of wearing visual aid 50 the horse is able to concentrate better and has more confidence in its movement and physical gait. All of these features enhance the relationship between horse and rider and the harmony between them. The rider in turn has greater confidence in their horse and therefore is better placed to understand the requests the horse makes and the importance of the visual workload placed upon the horse. This is especially the case when asking the horse to perform actions at speed or unusual angles—for example jumping fences, turning quickly (as required in polo), racing or pulling a trotting carriage.

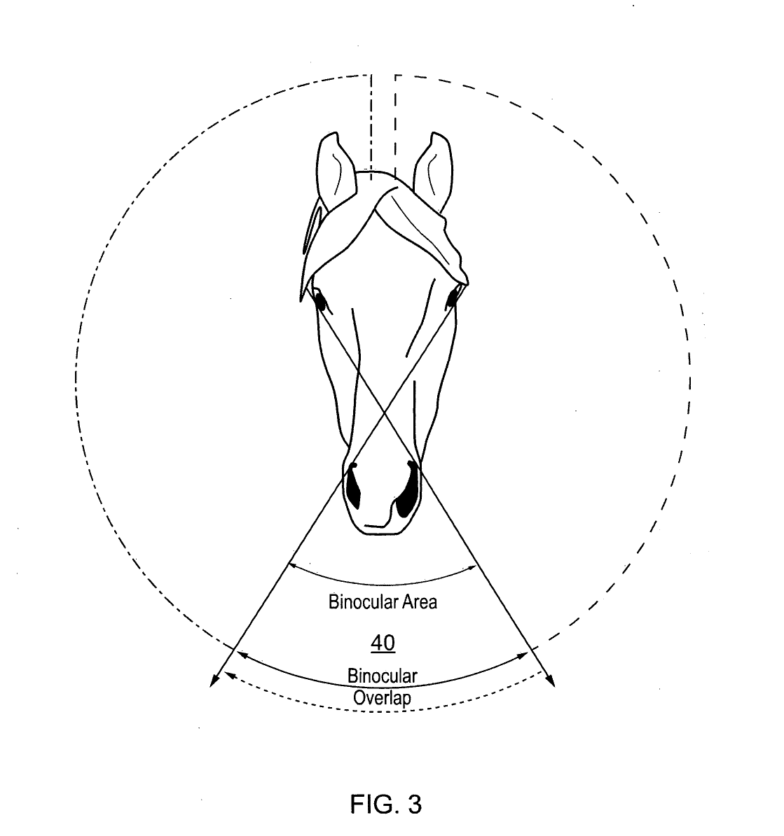

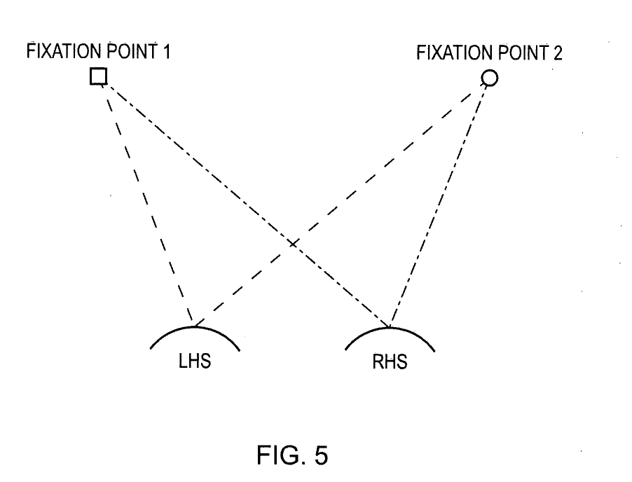

Blinkers and nosebands may have proved useful in the training of horses, however when horses race these appliances have the effect of altering the natural position in which the horse wants to hold its head. FIG. 3 shows how maximum extension (rotation) of the right and left eyes and how this creates an overlapping binocular area and FIG. 5 shows diagrammatically fixation points in a binocular visual field

Referring again to FIGS. 1 to 6 the areas and fields of view are shown from the perspective of a horse. Its eyes, in the space that is partitioned by the plane passing through each eye (FIG. 2), effectively sees an image that as a monocular view from either side, when the object is in the field of monocular vision 20 and 30; and as a binocular image, when the object (not shown) is in the region of monocular overlap 40.

FIG. 3 shows the relationship when viewed from the front and shows maximum extension (rotation) of the right and left eyes and how this creates the region of binocular overlap 40. FIGS. 5 and 6 depict fixation points in a binocular visual field. FIG. 5 illustrates the principle of how a horse's eye focuses and FIG. 6 shows how lateral portions 50a and 50b tend to draw the horse's eyes to an optimum central fixation point (shown as an equilateral triangle) intermediate the left and right extreme fixation points of binocular vision.

The visual aid may be used for any horse, regardless of age, size or occupation—for leisure or working tasks. As with many trained or behaviourally conditioned activities, the younger age that a horse can be introduced to proper binocular vision being employed, the better is the chance that its brain recognises images more quickly for interpretation.

Random analysis of humans asked to look at a blank space in front of themselves, when asked to pick 3 random points anywhere on a surface, generally give 2 horizontal points and a final third point some way—remarkably, in the population questioned,—equidistant between the first two points.

This showed that the human brain sees a space and creates a fixation point, a natural position between the two eyes, which forms the optimum viewing area. When the visual aids are placed vertically on the horse, a natural fixation viewing area is formed. When the horse is ridden on the bit, binocular vision is also achieved. Therefore any horse that is ridden with a physical bit in the mouth—and even those where a bitless bridle is employed still benefits from the equine visual aid.

In humans, vision is attributed to 80% of the sensory signals that the body requires for movement, thus being the most important sense. The combination of eye-hand-eye-foot coordination has been studied at length in humans. The equine visual aid takes these same principles, that if the horse's eyes are in the correct viewing position, balanced vision is achieved and improved eye-leg-hoof coordination results. This results in a straighter and more confident, faster movement and an increased forward trajectory. This has been a factor which is most important for domesticated horses when they are being ridden in a competitive arena.

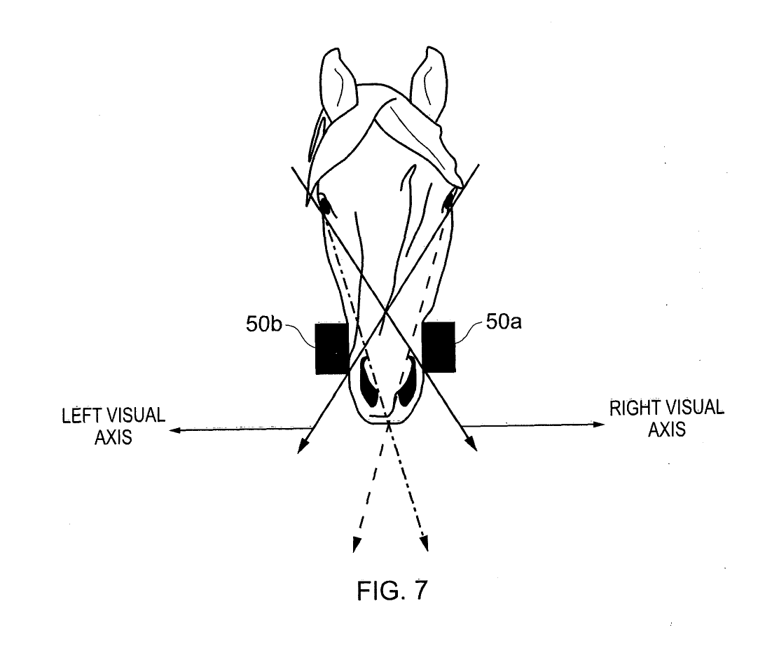

The inventor has realised the shortcomings of existing visual distracters (such as nosebands), shields and blinkers and so developed a visual aid, which is now descried in greater detail and with reference to FIGS. 7 to 16 in greater detail.

FIG. 4a is a front view of an embodiment of a visual aid 50 positioned in a vertical plane on the side of the bridge of the horse. FIG. 4b is a front view of an embodiment of a visual aid 50 positioned higher up on the cheek of the horse than the view in FIG. 4a. The arrows depict that the visual aid 50 is not only positioned higher up the cheek of the horse but further back, towards its eyes.

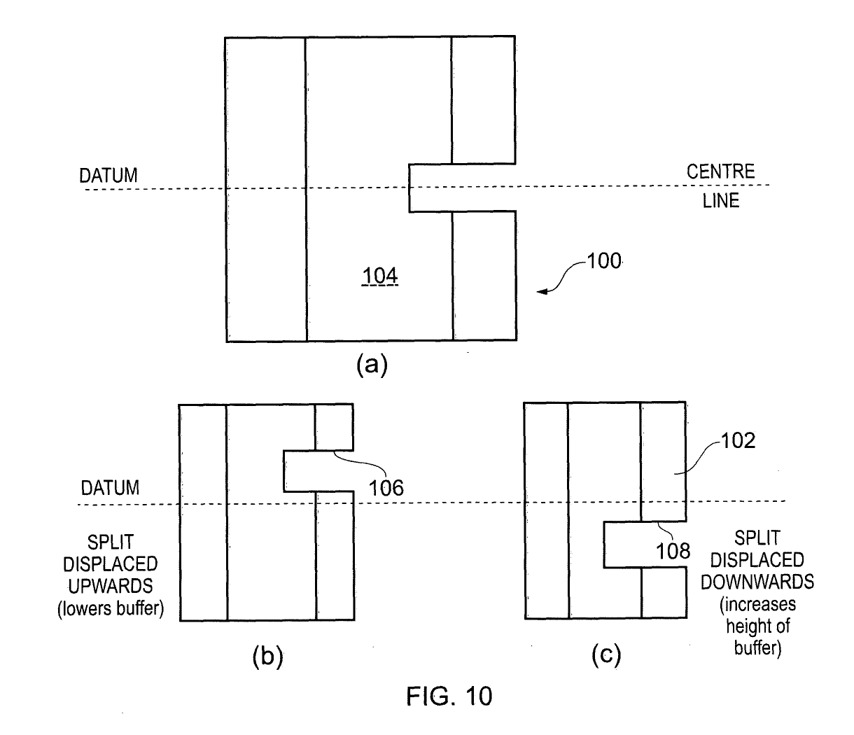

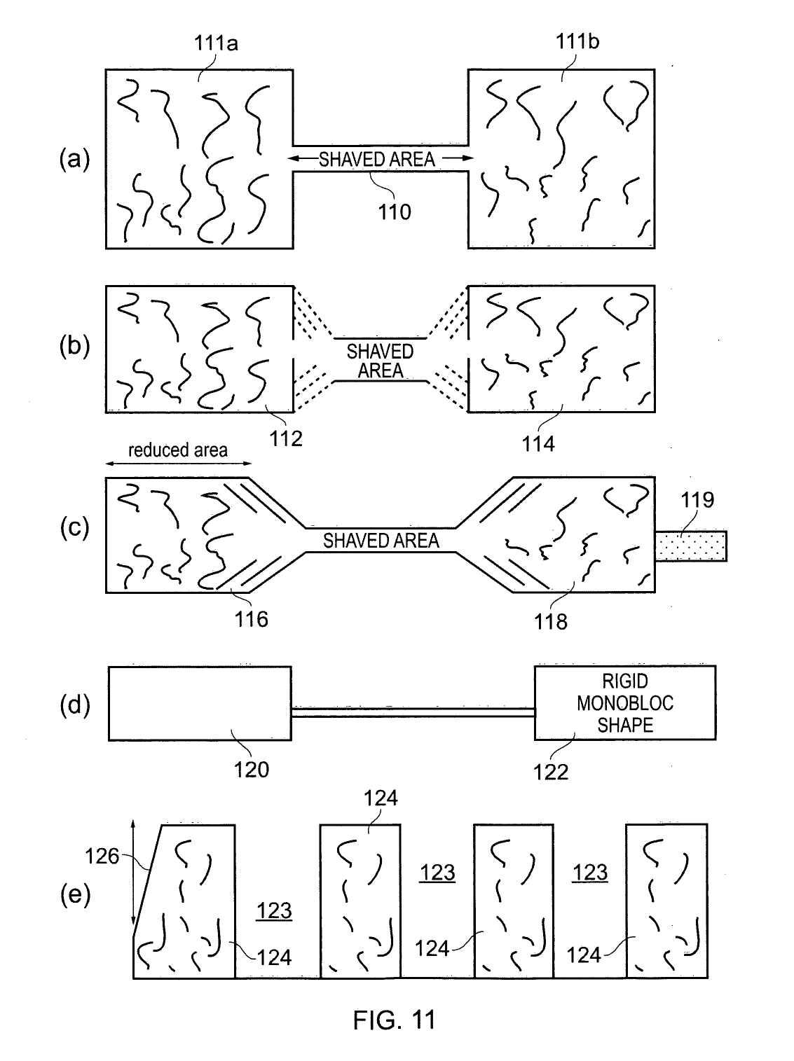

The visual aid, depicted in FIGS. 10 and 11 may be made from a single piece. There may be occasions when right and left buffers are joined together. In one embodiment the visual aid extends the full length of the horse's bridge, measured from one side below the jaw line, across the nasal area, to the same position on the other side. The attachment or connective addition to the visual aid may also used where a standard noseband is not employed. This allows for a stable and secure fitting of the visual aid

Referring to FIGS. 11a and 11d, visual aid 50 may include a piece of sheepskin with two equal lengths 111a and 111b, which are the width of the horse's bridge. A shaved central portion 110 is removed to create a flat, suede effect connector. The lateral portions or buffers are left in a “raw” or unshaven state creating a desired visual effect. This serves to anchor the buffers together across the top of the horse's face and prevent loss of individual buffers. A similar ‘under-the-chin’ connection may be made by continuing the pieces and shaving an additional length, as in diagram, which can be joined below the horse's mouth, for example by a buckle or hook and loop tape.

FIGS. 11b, 11c and 11d show alternative embodiments where the middle shaved area may also be contoured or designed to create a narrowing aperture from the internal edge of the visual aid to increase or reduce the contact area of the whole bridging shaven area, depending upon where the removal of wool is started. This design may also be contoured on the single buffer.

The internal area of the visual aid 50 may also be made in a graduating format around edge region 126 as shown in FIG. 11e, in order to create a gentle increase in the height of the wool. The tapering effect may vary from the wool edge to expose bare areas 123 between regions or finger-like protrusions of the buffers. Alternatively the wool regions 124 may be non-graduated, that the wool is trimmed closely to the area which passes over the bridge or shaved are, in effect creating a small dense area at the top of the buffer, whether or not a connecting strap is utilised.

The use of synthetic or hypo-allergenic materials may also be substituted in order to reduce manufacturing costs and in some sensitive horses. This avoids any physical skin reactions from pigments and chemicals used in the tanning and dyeing processes of natural sheepskin or lambs wool. Other types of natural material include: animal skin with a pile.

The visual aid may also be made out of a preformed block of synthetic material, in the form of a cuboid or rectangular block, which may also be contoured as the sheepskin counterpart design, as a single unit or a connected monobloc shape. Harder materials such as wood, synthetic rubber or coated metal may also be used to form the buffer structure.

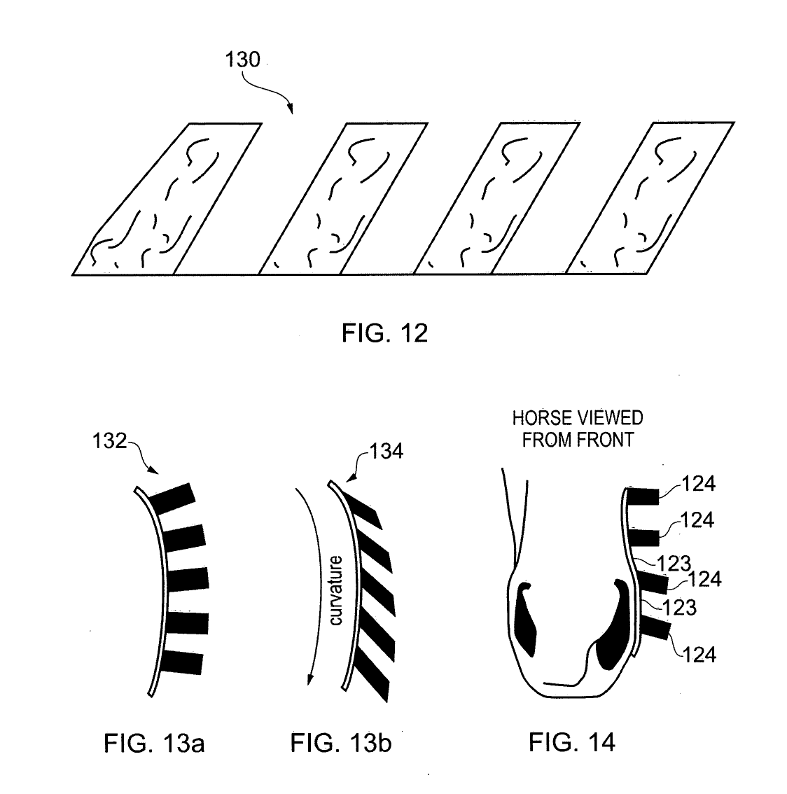

The solid nature of the visual aid 50 may also be carved or moulded into a certain shape to create a castellated effect, where a grid or zigzag design can be incorporated into the substance of the visual aid, as shown for example in FIGS. 12 and 13. Apertures may be within the fabric, so as to create the effect of a shaped hole or gap within the sheepskin or synthetic materials. If diagonal cuts 132 and 134 are created these may be designed at differing angles with the outer peripheral regions defined along the outer edge of the visual aid 50 and being angled towards the centre of the horse's bridge or outwards, away from the line of sight. These embodiments may be complementary in being of the same direction or opposing each other.

These latter two embodiments in use lie against the facial features and contours of the horse, creating a curvature of shape, when seen in the vertical position, as shown in FIG. 14.

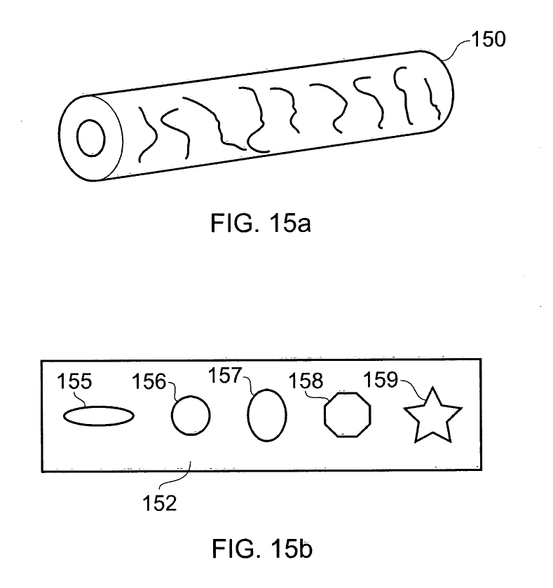

Stitching so as to create a contact between the two edges of the visual aid 50 may also be used to create a tubular design of the visual aid, as shown in FIG. 15a and described in detail below. The tubular design or tube 150 is therefore adapted with a slit to be slipped along a leather noseband 84 (as seen in FIG. 8) and kept in position by friction or secured with additional connections to the bridle 82.

Referring to FIG. 15a, there is shown diagrammatically an alternative embodiment of a visual aid 150 comprising tubular formation from a roll of material, such as synthetic foam or rubberoid or fabric or knitted fibre or a solid material.

FIG. 15b shows in diagrammatic form only, five alternative shapes that may be formed in, or cut from, the visual aid 152, which is shown opened and flat. The different shapes are shown as having been cut and are oval 155 and 157, circular 156, polygonal, specifically octagonal 158 and star shaped 159. These shapes are examples and are shown for illustrative purposes only and may be in the same form or different so as to create an individual aperture or a series of apertures across the length of the visual aid 154.

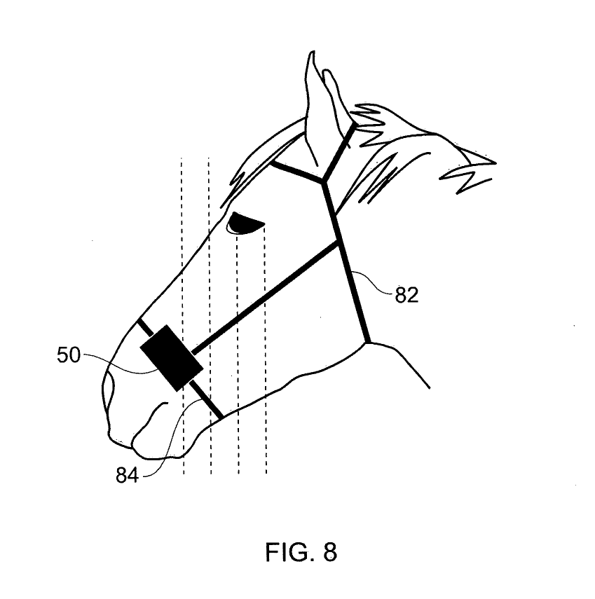

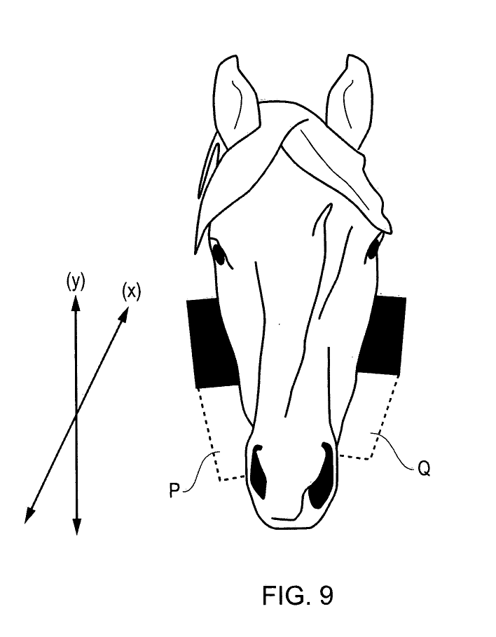

The height or length of the visual aid may be varied according to the particular requirements of a horse or its ophthalmic characteristics. For example a horse that is more dominant in one eye than the other, might require visual aid where the buffers 50a and 50b are asymmetric, as depicted in exaggerated form in FIG. 9 and indicted by the letters P and Q. For example one buffer on one cheek may be smaller than the other or it might be increased to continue under the horse's chin. It may also be that only one predominant buffer is used on one side of the horse's cheek.

Alternatively the visual aid may be positioned closer to the eye, either one or both, dependent upon the anatomical features of the horse, Inwards or further away to the nasal extreme, where there is no conflict to the animal for breathing or physical comfort.

Fluorescent dyes, paints, markers or other passive light sources can be incorporated into the visual aid or the fabric/material from which it is formed. An advantage with such fluorescent dyes or markers is that it enables the visual aid to be seen at night and used in darkness or low light levels. Likewise it assists in the illumination and visual tracking of a horse by a remote observer. Other active light sources, such as electric light sources and light emitting diodes (LEDs) may be included in the visual aid, again so as to assist in tracking and observing performance from a distance.

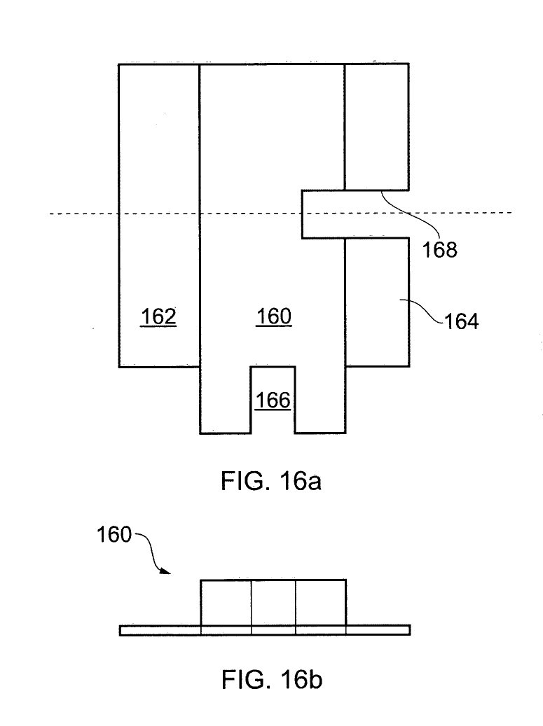

FIGS. 16a and 16b are plan and side elevation views of another embodiment of a visual aid. There is shown a portion of sheepskin 160 mounted on and supported by a flexible sheet 162. Notches or lateral cut portions 166 and 168 are shown removed and these adapt the visual aid for fitting over the bridle 84 and halter 82. Reference is now made to the corresponding cut portions 106 and 108 that are formed in the visual aid and depicted in FIG. 10. These enable adjustments of the visual aid 100 in direction above and below a notional datum. The practical effect of this is to enable adjustment of the visual aid up and down the horse's cheek, as shown in FIG. 9.

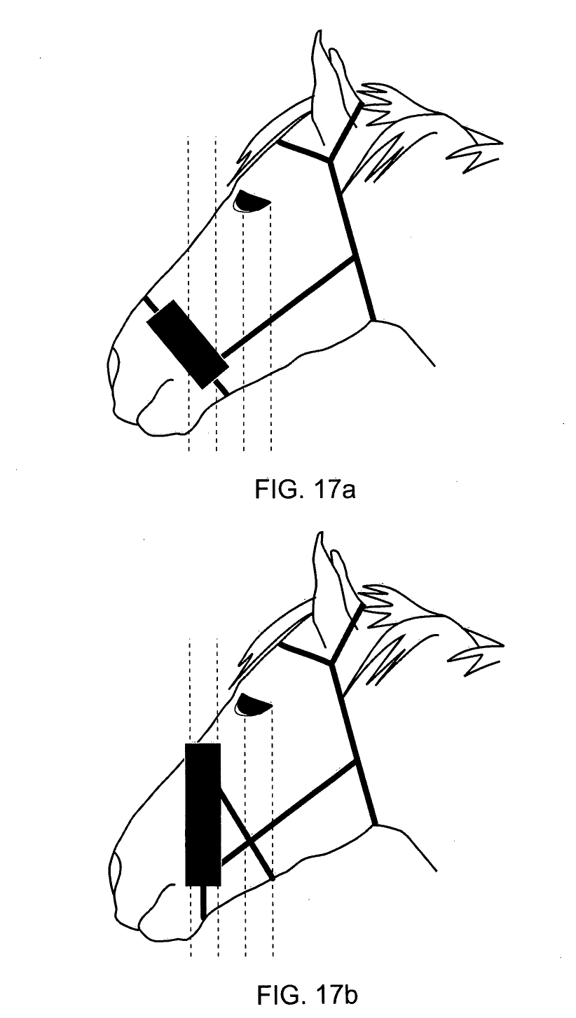

FIGS. 17a and 17b show alternate positions of the buffer when it placed on differing styles of existing nosebands.

From the foregoing it is appreciated that there is no other type of device which creates a forward natural fixation point for an animal, whilst not obstructing the animal's peripheral vision.

The invention has been described by way of examples only and it will be understood that the invention may take a form different to that specifically described above. For example modifications will be apparent to those skilled in the art without departing from the scope of the present invention. For example the visual aid may be used in horse racing.

It is further understood that the invention may be employed in other animal or bird environments for example for the handling or racing of dogs, larger mammals and birds, such as ostrich or emu racing.

1. A visual aid comprising:
first and second lateral portions that are adapted to be worn by an animal so that, in use, the first lateral portion is located on a lateral side of the head of the animal in line of the frontal visual axis of the left eye of the animal and between the nostril; and
the second lateral portion is located on a lateral side of the head of the animal in line of the frontal visual axis of the right eye of the animal and between the nostril.

2. A visual aid according to claim 1 wherein the visual aid includes a buffer or roll made of sheepskin.

3. A visual aid according to claim 1 wherein, in use, the lateral portions are detachably mounted to a bridle.

4. A visual aid according to claims 1 wherein the portions are adapted to create an area in front of the eyes of the animal wearing the visual aid, which encourages the animal to focus within a frame defined by the visual aid.

5. A visual aid according to claim 1 wherein the lateral portions are in the form of a simple contoured shape adapted to hug the horse's facial features.

6. A visual aid according to claim 5 wherein the lateral portions are dimensioned and arranged to form a shadow or darkened area in the region of frontal vision of the horse.

7. A visual aid according to claim 1 wherein the visual aid is typically one or more piece(s) which has/have been cut into generally square or rectangular shape.

8. A visual aid according to claim 1 wherein the length of material on the surface of the visual aid varies between 1-4 cm.

9. A visual aid according to claim 1 wherein the size of the visual aid is determined by the measurement equal to the distance from the side of the bony bridge of the horse's face so that, in use, it meets the virtual line or intersection of the measurement taken along the line of the outer canthus of the eye orbit to the horse's nostril, on the corresponding side.

10. A visual aid according to claim 1 wherein the visual aid has a flatter aspect ratio is sausage shaped or tubular in design.

11. A visual aid according to claim 1 wherein the visual aid is attachable to an existing bridle by hook and eye, Velcro (Registered Trade Mark) fastening or a a hook and loop tape or by slits cut within the rear backing or attached directly to the face with adhesive or adhesive tape.

12. A visual aid according to claim 11 wherein tapes or backing is/are provided which permit a noseband to slide easily through the openings.

13. (canceled)
